(19) United States
(12) Patent Application Publication
(10) Pub. No.: US 2024/0342816 A1
(43) Pub. Date: Oct. 17, 2024

(54) ARC SPOT WELDING METHOD FOR JOINING DISSIMILAR MATERIALS, AND DISSIMILAR MATERIAL WELDED JOINT

(71) Applicant: Kabushiki Kaisha Kobe Seiko Sho (Kobe Steel, Ltd.), Kobe-shi (JP)

(72) Inventors: Kaname TODA, Fujisawa-shi (JP); Reiichi SUZUKI, Fujisawa-shi (JP); Yoichiro SHIMODA, Fujisawa-shi (JP)

(73) Assignee: Kabushiki Kaisha Kobe Seiko Sho (Kobe Steel, Ltd.), Kobe-shi (JP)

(21) Appl. No.: 18/294,562

(22) PCT Filed: Aug. 22, 2022
(86) PCT No.: PCT/JP2022/031619

§ 371 Date: Feb. 2, 2024

(30) Foreign Application Priority Data
Aug. 23, 2021 (JP) 2021-135926

(51) Int. Cl. B23K 9/007; B23K 9/173; B23K 9/23

(52) U.S. Cl. CPC B23K 9/007; B23K 9/173; B23K 9/23

(57) ABSTRACT

This arc spot welding method for dissimilar materials joins a steel upper plate and a non-ferrous metal lower plate. The upper plate has a flat plate-like base part and an upright wall part erected on the base part. The base part has a through-hole. The arc spot welding method for dissimilar materials includes superposing the base part on the lower plate so that the lower plate faces the base part via the through-hole; and arc-welding the base part and the lower plate by filling the through-hole with a molten weld metal at a position, which is a target position, offset in the direction opposite the upright wall part from the center of the through-hole.

### TECHNICAL FIELD

The present invention relates to an arc spot welding method for joining dissimilar materials, and a dissimilar material welded joint.

### BACKGROUND ART

In transport equipment, such as automobiles, improvement of mileage is always required for the purpose of various control of (a) consumption of petroleum fuels, which are limited resources, (b) a global greenhouse gas CO2 generated by combustion, and (c) running cost. In addition to the improvement of power system technology, such as the use of electric drive, one of the improvement measures is to reduce the weight of the bodywork. To reduce the weight, the present main material, steel, may be replaced with a lightweight material, such as an aluminum alloy, a magnesium alloy, or carbon fiber. To completely replace steel with these lightweight materials, however, there are problems, such as higher cost and insufficient strength, and as a solution, a design method called multi-material, which combines steel and a lightweight material in the right place, is attracting attention.

To combine steel and a lightweight material, there is inevitably a portion at which these are joined. It is known that although welding between steels, between aluminum alloys, and between magnesium alloys is easy, welding between dissimilar materials is extremely difficult. This is because an intermetallic compound (IMC), which is extremely brittle, is formed in a melt-mixed portion of steel and aluminum or magnesium, and the melt-mixed portion is easily broken by external stress, such as tension or impact. For this reason, a welding method, such as a resistance spot welding method or an arc welding method, cannot be used to join dissimilar materials, and another joining method is generally used. Welding cannot be used to join steel and carbon fiber because the latter is not metal.

Patent Literature 1 discloses an arc spot welding method for joining dissimilar materials for joining a first sheet made of an aluminum alloy or a magnesium alloy and a second sheet made of steel.

This welding method includes the step of drilling a hole in the first sheet;
the step of superimposing the first sheet and the second sheet;
the step of arranging a joining auxiliary member made of steel, in which a circular hole portion is to be formed, on the first sheet such that the hole portion is coaxial with the hole formed in the first sheet; and
the step of filling the hole portion of the joining auxiliary member with a weld metal and arc-welding the second sheet and the joining auxiliary member via the weld metal in the hole of the first sheet. Thus, the weld metal and a portion of the molten second sheet and joining auxiliary member form a fusion zone and join the first sheet and the second sheet.

Non-patent Literature 1 describes that a steel sheet and an aluminum sheet are joined by a MIG spot welding method using an aluminum welding wire. This MIG spot welding method includes forming one through-hole in the steel sheet in advance, placing the steel sheet on the aluminum sheet, and filling the hole of the steel sheet with a molten aluminum member to join the steel sheet and the aluminum sheet.

### CITATION LIST

### Patent Literature

PTL 1: Japanese Unexamined Patent Application Publication No. 2018-034166

### Non Patent Literature

NPL 1: WELDING JOURNAL, (1963), pp. 302-308

### SUMMARY OF INVENTION

### Technical Problem

The welding method disclosed in Patent Literature 1 requires a joining auxiliary member as a consumable material. Thus, there is a need for a simpler and inexpensive technique without a joining auxiliary member.

In contrast, a steel sheet and an aluminum sheet can be joined by the joining method described in Non-patent Literature 1 without a joining auxiliary member. However, the arc shape, the tendency of magnetic arc blow to occur, and the like characteristic of MIG welding may reduce the rigidity of the arc and cause a problem, such as cracking when the steel is partially melted and mixed into weld metal, or an unstable weld metal shape.

In particular, when a steel sheet has a base portion to be superimposed on an aluminum sheet and an upright wall standing on the base portion, extensive studies of the present inventors show a phenomenon in which magnetic arc blow deflects the arc and weld metal toward the upright wall. This significantly increases cracking and worsens the unstable weld metal shape as described above, which adversely affects the quality.

The present invention has been made in view of these problems and aims to provide an arc spot welding method for joining dissimilar materials, which can join dissimilar materials of a first sheet made of steel and a second sheet made of nonferrous metal with high strength and high reliability, and a dissimilar material welded joint.

### Solution to Problem

The objects of the present invention are achieved by the following [1] relating to an arc spot welding method for joining dissimilar materials.

[1] An arc spot welding method for joining dissimilar materials for joining a first sheet made of steel and a second sheet made of nonferrous metal, wherein
the first sheet has a flat base portion and an upright wall standing on the base portion, and
the base portion has a through-hole, and the method includes: a superimposing step of superimposing the base portion on the second sheet such that the second sheet is exposed through the through-hole; and
a filling and welding step of filling the through-hole with a molten weld metal at a target position shifted from a center of the through-hole in the direction opposite to the upright wall and arc-welding the base portion and the second sheet.

### Advantageous Effects of Invention

The present invention can provide an arc spot welding method for joining dissimilar materials for joining a first sheet made of steel and a second sheet made of nonferrous metal with high strength and high reliability, and a dissimilar material welded joint.

### BRIEF DESCRIPTION OF DRAWINGS

FIG. 1 is a perspective view of a dissimilar material welded joint according to an embodiment of the present invention.

FIG. 2 is a cross-sectional view of a dissimilar material welded joint.

FIG. 3 is a cross-sectional picture of a dissimilar material welded joint around a through-hole.

FIG. 4A is an explanatory view of a working process of an arc spot welding method for joining dissimilar materials and is a view of a drilling step and a superimposing step of the arc spot welding method for joining dissimilar materials.

FIG. 4B is an explanatory view of the working process of the arc spot welding method for joining dissimilar materials and is a view of a filling and welding step of the arc spot welding method for joining dissimilar materials.

FIG. 4C is an explanatory view of the working process of the arc spot welding method for joining dissimilar materials and is a view of a dissimilar material welded joint produced by the arc spot welding method for joining dissimilar materials.

FIG. 5 is a cross-sectional view of an upper sheet and a lower sheet for explaining an arc spot welding method for joining dissimilar materials according to a comparative example.

FIG. 6 is a cross-sectional picture of a dissimilar material welded joint around a through-hole according to a comparative example.

FIG. 7 is a top view of a dissimilar material welded joint according to a comparative example.

FIG. 8 is a cross-sectional picture of a dissimilar material welded joint around a through-hole according to the present embodiment.

FIG. 9 is a perspective view of an upper sheet and a lower sheet according to a first modified example.

FIG. 10 is a cross-sectional view of a dissimilar material welded joint around a through-hole according to a second modified example.

FIG. 11 is a cross-sectional view of a dissimilar material welded joint around a through-hole according to a third modified example.

FIG. 12 is a perspective view of a test joint for a cross tensile test.

FIG. 13 is a cross-sectional view of a test joint around a through-hole.

FIG. 14 is a graph of the results of a cross tensile test.

### DESCRIPTION OF EMBODIMENTS

An arc spot welding method for joining dissimilar materials and a dissimilar material welded joint according to an embodiment of the present invention are described in detail below with reference to the drawings.

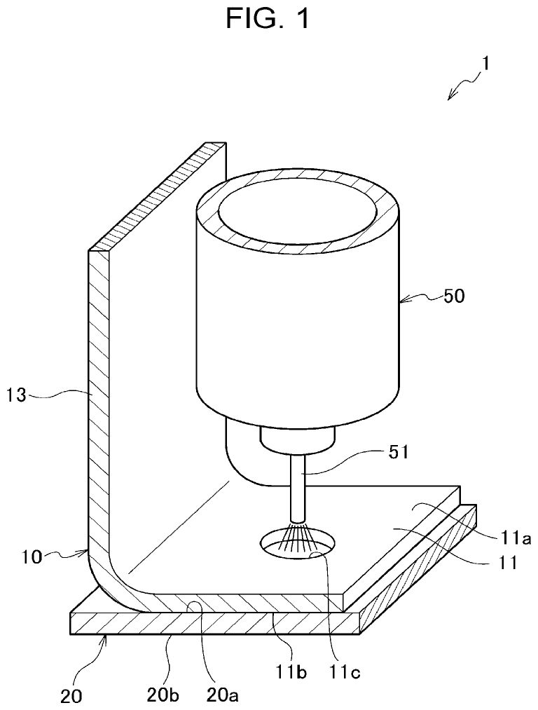

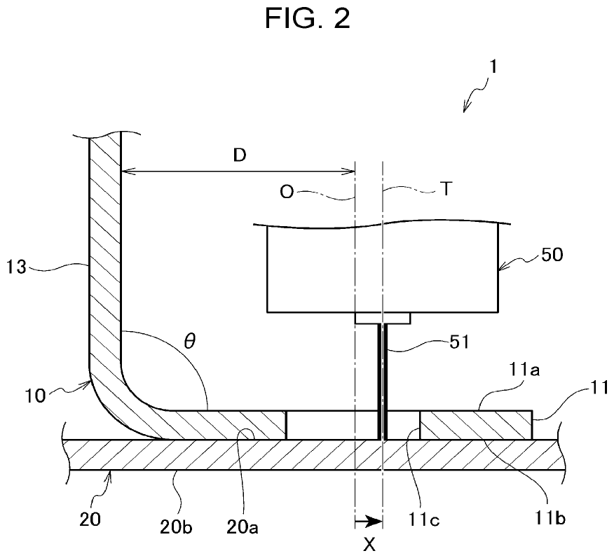

FIG. 1 is a perspective view of a dissimilar material welded joint 1 according to an embodiment of the present invention. FIG. 2 is a cross-sectional view of the dissimilar material welded joint 1. FIGS. 1 and 2 illustrate the dissimilar material welded joint 1 during welding with an arc welder 50, and a weld metal 30 for joining an upper sheet 10 and a lower sheet 20 is not shown. In the arc spot welding method for joining dissimilar materials of the present embodiment, the upper sheet 10 made of steel (first sheet) and the lower sheet 20 made of nonferrous metal (second sheet) to be superimposed are joined by an arc spot welding method for joining dissimilar materials described later to produce the dissimilar material welded joint 1 as illustrated in FIGS. 1 and 2.

The upper sheet 10 is a steel sheet with an L-shaped cross section having a flat base portion 11 and an upright wall 13 standing on the base portion 11. The base portion 11 has a front surface 11a and a back surface 11b, which is a surface opposite the front surface 11a and abuts on the lower sheet 20. A circular through-hole 11c extending from the front surface 11a to the back surface 11b in the thickness direction and facing a front surface 20a of the lower sheet 20 is formed in the base portion 11. The shape of the through-hole 11c is not limited to circular and may be polygonal or the like.

The upright wall 13 extends perpendicularly to the base portion 11 from one end portion of the base portion 11. Although the base portion 11 and the upright wall 13 form an angle θ of 90 degrees in the illustrated example, the present invention is not limited to this angle, and the angle θ may be in the range of 0 degrees <θ<180 degrees.

The lower sheet 20 is made of, for example, a nonferrous metal, such as aluminum, an aluminum alloy, magnesium, a magnesium alloy, copper, or a copper alloy. The lower sheet 20 is a flat sheet extending parallel to the base portion 11 of the upper sheet 10. The lower sheet 20 has the front surface 20a, which abuts on the back surface 11b of the base portion 11, and a back surface 20b, which is a surface opposite the front surface 20a.

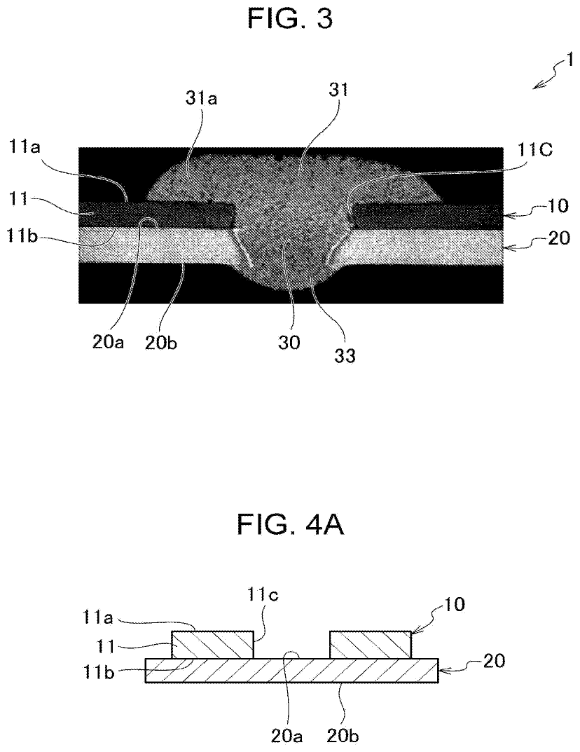

FIG. 3 is a cross-sectional picture of the dissimilar material welded joint 1 around the through-hole 11c. As illustrated in FIG. 3, the through-hole 11c in the base portion 11 of the upper sheet 10 is filled with the weld metal 30 of aluminum or an aluminum alloy in which a filler material (welding material) is melted by arc spot welding, the lower sheet 20 is thereby partially melted, and the weld metal 30 joins the upper sheet 10 and the lower sheet 20.

The weld metal 30 fills the through-hole 11c and forms an excess weld 31 on the front surface 11a side of the base portion 11. The excess weld 31 has a flange portion 31a extending to the outer peripheral side from the peripheral surface of the through-hole 11c. If the excess weld 31 is not formed, that is, if the through-hole 11c seemingly remains after welding, the joint strength may be insufficient for external stress in the thickness direction of the base portion 11 and the lower sheet 20. Thus, the formation of the excess weld 31 as in the present embodiment can provide high joint strength.

On the other hand, the penetration of the weld metal 30 on the side opposite the excess weld 31 side should appropriately melt the lower sheet 20. As shown in FIG. 3, the weld metal 30 may be formed beyond the thickness of the lower sheet 20, that is, the lower sheet 20 may be melted such that a so-called penetration bead 33 appears. On the other hand, the weld metal 30 just resting on the lower sheet 20 without melting the lower sheet 20 cannot provide high strength. Furthermore, welding should be performed such that the weld metal 30 does not penetrate too deeply and the weld metal 30 and the lower sheet 20 are not melted down.

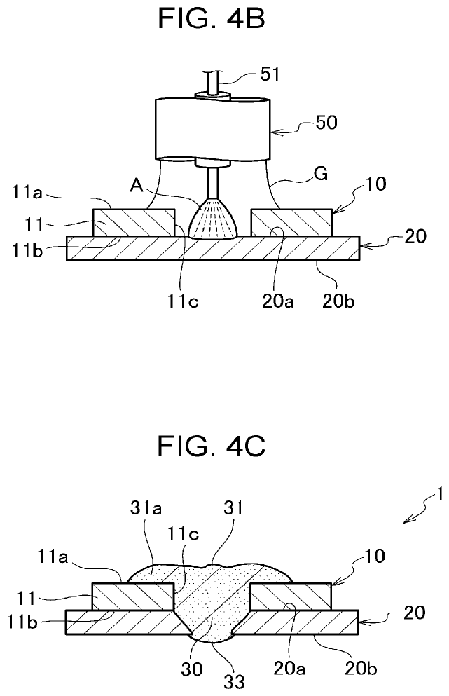

FIGS. 4A to 4C are explanatory views of a working process of an arc spot welding method for joining dissimilar materials and are cross-sectional views of the upper sheet 10 and the lower sheet 20 around the through-hole 11c. FIG. 4A is a view of a drilling step and a superimposing step of the arc spot welding method for joining dissimilar materials. FIG. 4B is a view of a filling and welding step of the arc spot welding method for joining dissimilar materials. FIG. 4C is a view of the dissimilar material welded joint 1 produced by the arc spot welding method for joining dissimilar materials.

The arc spot welding method for joining dissimilar materials is described below. First, as illustrated in FIG. 4A, the base portion 11 of the upper sheet 10 is subjected to the drilling step of forming the through-hole 11c extending from the front surface 11a to the back surface 11b in the thickness direction and facing the interface of the lower sheet 20 (step S1). A specific method in the drilling step may be (A) milling with a rotating tool, such as an electric drill or a drilling machine, (B) punching with a punch, or (C) press die cutting with a die.

Next, the superimposing step of superimposing the base portion 11 of the upper sheet 10 and the lower sheet 20 is performed (step S2).

Subsequently, as illustrated in FIGS. 4B and 4C, the filling and welding step of filling the through-hole 11c with the molten weld metal 30 and arc-welding the base portion 11 and the lower sheet 20 is performed (step S3). In the filling and welding step, the arc welder 50 is used to generate an arc A by a consumable electrode gas-shielded arc welding method, and a welding wire 51 is melted under welding conditions that do not melt the base portion 11 of the upper sheet 10, thereby joining the base portion 11 and the lower sheet 20.

The consumable electrode gas-shielded arc welding method is a welding method generally called MAG or MIG, in which the welding wire 51, such as a solid wire or a flux-cored wire, is used as a filler and also as an arc generating consumable electrode, and an appropriate weld is formed by shielding the weld from the atmosphere with a shielding gas G, such as CO2, Ar, or He.

In such arc welding, the through-hole 11c in the base portion 11 is filled with the weld metal 30 produced by melting of a filler material. Thus, the excess weld 31 is formed on the front surface 11a of the upper sheet 10, and the weld metal 30 is melted such that the penetration bead 33 appears on the back surface 20b of the lower sheet 20, thereby joining the base portion 11 and the lower sheet 20.

In the present embodiment, the type and shape of the upper sheet 10 made of steel are not particularly limited and are appropriately selected from applications commonly used for structural members or structural member applications. As long as the effects of the dissimilar-material joining method according to the present embodiment are not impaired, galvanization or another plating (a plated steel sheet) or various surface treatments may be applied.

The lower sheet 20 made of an aluminum alloy or a magnesium alloy is, for example, an aluminum member, such as a pure aluminum member or an aluminum alloy member, or a magnesium member, such as a pure magnesium member or a magnesium alloy member. The type and shape of an alloy in the lower sheet 20 used in the present embodiment are not particularly limited, and a sheet material, such as a rolled material, an extrusion profile, such as an extruded material, a forged material, a cast material, or the like, which is commonly used, is appropriately selected according to the required characteristics of each structural member.

An aluminum alloy applied to the lower sheet 20 may be a 5000 series (Al—Mg series), a 6000 series (Al—Mg—Si series), or the like, and any alloy can be used in the present embodiment. A magnesium alloy applied to the lower sheet 20 may be MSAZ31B, MS-AZ61, MS-AZ80, MS-M1, MS-AZX611, or the like of JIS standards.

The filler material (welding material) can be a generally used welding wire and is appropriately selected for each welded joint depending on welding conditions. More specifically, the filler material (welding material) is used such that the weld metal 30 is the same as the material of the lower sheet 20. The welding wire may be a solid wire or a flux-cored wire.

For example, when the lower sheet 20 is made of aluminum or an aluminum alloy, the filler material (welding material) is used such that the weld metal 30 is aluminum or the aluminum alloy. The aluminum welding material is, for example, but not limited to, A4043-WY, A4047-WY, A5356-WY, A5183-WY, or the like specified by JIS.

When the lower sheet 20 is made of magnesium or a magnesium alloy, the filler material (welding material) is used such that the weld metal 30 is magnesium or the magnesium alloy. When the lower sheet 20 is made of copper or a copper alloy, the filler material (welding material) is used such that the weld metal 30 is copper or the copper alloy.

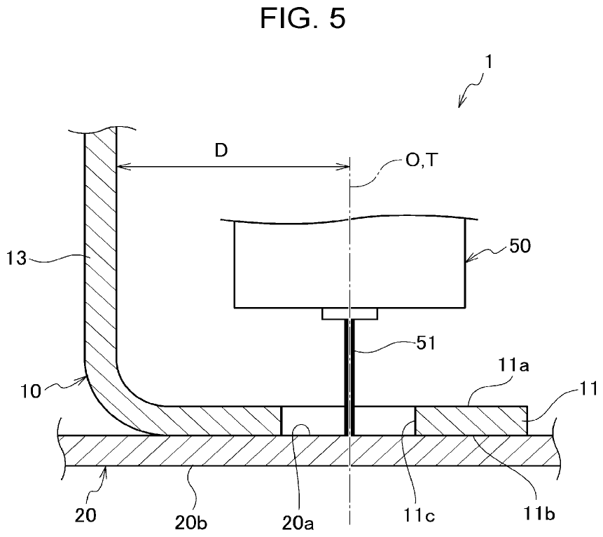

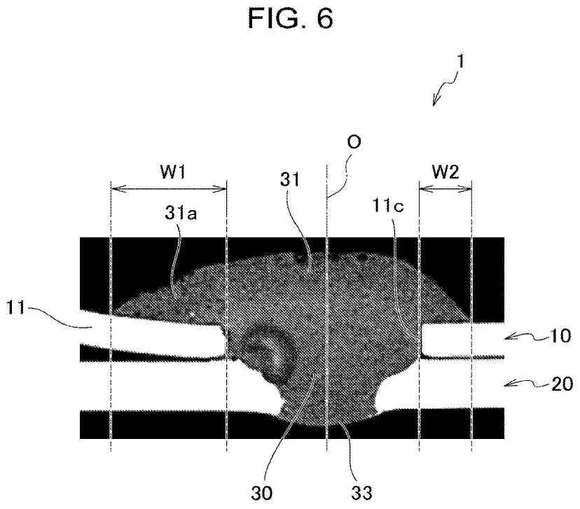

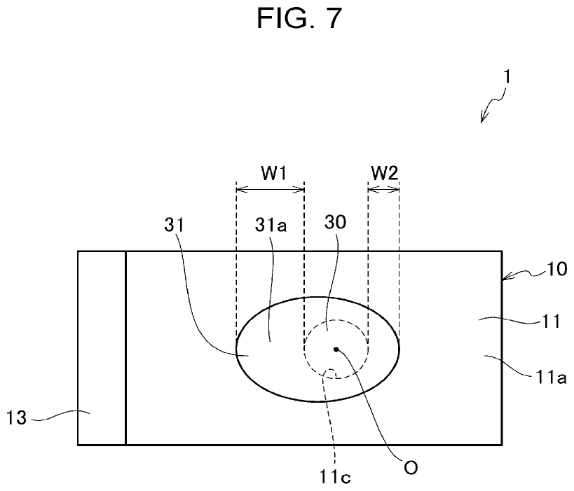

FIG. 5 is a cross-sectional view of the upper sheet 10 and the lower sheet 20 for explaining an arc spot welding method for joining dissimilar materials according to a comparative example. FIG. 6 is a cross-sectional picture of the dissimilar material welded joint 1 around the through-hole 11c according to a comparative example. FIG. 7 is a top view of the dissimilar material welded joint 1 according to a comparative example.

As illustrated in FIG. 5, in the filling and welding step (step S3), when the target position (teaching point) T of the welding wire 51 is the center O of the through-hole 11c of the base portion 11, a magnetic arc blow is generated and impairs the rigidity of the arc due to the upright wall 13 of the upper sheet 10, which is a magnetic material. In particular, when the distance D between the center O of the through-hole 11c and the upright wall 13 is 15 mm or less, the magnetic arc blow has a large effect. As a result, the arc is deflected toward the upright wall 13, and as shown in FIGS. 6 and 7, the weld metal 30 is also deflected toward the upright wall 13 (the left side in FIGS. 6 and 7). More specifically, the amount of extension W1 of the flange portion 31a of the excess weld 31 of the weld metal 30 from the peripheral surface of the through-hole 11c toward the upright wall 13 side is larger than the amount of extension W2 of the flange portion 31a from the peripheral surface of the through-hole 11c in the direction opposite to the upright wall 13 (W1>W2).

In such a case, a portion of the upper sheet 10 as the front member may be excessively melted and mixed into the weld metal 30, thereby compromising the quality of the weld metal 30. Furthermore, the flange portion 31a of the excess weld 31 of the weld metal 30 is not formed in an ideal perfect circular shape, and the strength may be lowered.

Thus, in the present embodiment, in expectation of the amount of the arc and the weld metal 30 deflected toward the upright wall 13 by the magnetic arc blow, as illustrated in FIG. 2, arc welding is performed in the filling and welding step (step S3) with a position shifted from the center O of the through-hole 11c in the direction opposite to the upright wall 13 as the target position (teaching point) T of the welding wire 51.

The distance between the center O of the through-hole 11c and the upright wall 13 is denoted by D, and the distance between the center O of the through-hole 11c and the target position T is denoted by X. Here, as the distance X, the amount of deviation of the target position T from the center O of the through-hole 11c in the direction opposite to the upright wall 13 (on the right side in the drawing) is a positive value, and the amount of deviation of the target position T from the center O of the through-hole 11c in the direction toward the upright wall 13 (on the left side in the drawing) is a negative value.

In this case, it is preferable to satisfy 0.5/log(1+D)≤X, and it is more preferable to satisfy 2.0/log(1+D)≤X. Setting the distance X in these ranges increases the distance (D+X) between the target position T and the upright wall 13, so that even when the weld metal 30 is deflected toward the upright wall 13 by the magnetic arc blow, the target position T is shifted by the distance X to the side opposite the upright wall 13, thus resulting in the weld metal 30 with high circularity with respect to the center O of the through-hole 11c as a reference.

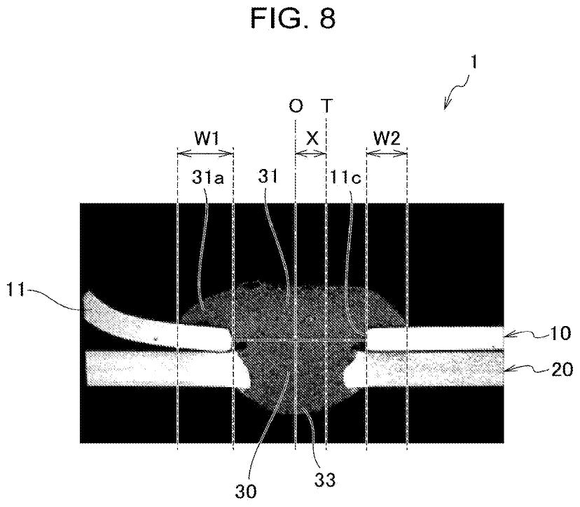

FIG. 8 is a cross-sectional picture of the dissimilar material welded joint 1 around the through-hole 11c according to the present embodiment. As shown in FIG. 8, the weld metal 30 has high circularity, and the relationship between the amounts of extension W1 and W2 of the flange portion 31a of the excess weld 31 can be W1/W2≤2.5, more preferably W1/W2≤1.4.

On the other hand, X<0.5/log(1+D) may result in 2.5<W1/W2 due to the effects of the magnetic arc blow, the amount of extension W1 excessively larger than the amount of extension W2, the flange portion 31a of the excess weld 31 of the weld metal 30 not formed in an ideal perfect circular shape, and lower strength.

It is preferable to satisfy X≤5.0/log(1+D), and it is more preferable to satisfy X≤3.5/log(1+D). Setting the distance X in these ranges can result in the weld metal 30 with high circularity and the relationship between the amount of extensions W1 and W2 of the flange portion 31a of the excess weld 31 being 0.4≤W1/W2, preferably 0.7≤W1/W2.

On the other hand, 5.0/log(1+D)<X may result in a large distance X of the target position T from the center O, W1/W2<0.4, the amount of extension W2 excessively larger than the amount of extension W1, the flange portion 31a of the excess weld 31 of the weld metal 30 not formed in an ideal perfect circular shape, and lower strength.

As described above, in the present embodiment, when arc welding is performed so as to satisfy 0.5/log(1+D)≤X5.0/log(1+D) with a position shifted by the distance X from the center O of the through-hole 11c in the direction opposite to the upright wall 13 as the target position T of the welding wire 51, 0.4≤W1/W2≤2.5 is satisfied, and the weld metal 30 has improved circularity. Thus, even when the distance D between the center O of the through-hole 11c and the upright wall 13 is small (for example, the distance D is 15 mm or less) and the magnetic arc blow has a large effect, the base portion 11 of the upper sheet 10 and the lower sheet 20 can be joined with high strength and high reliability. To further increase the joint strength, it is more preferable to satisfy 0.7≤W1/W2≤1.4 to increase the circularity of the weld metal.

### First Modified Example

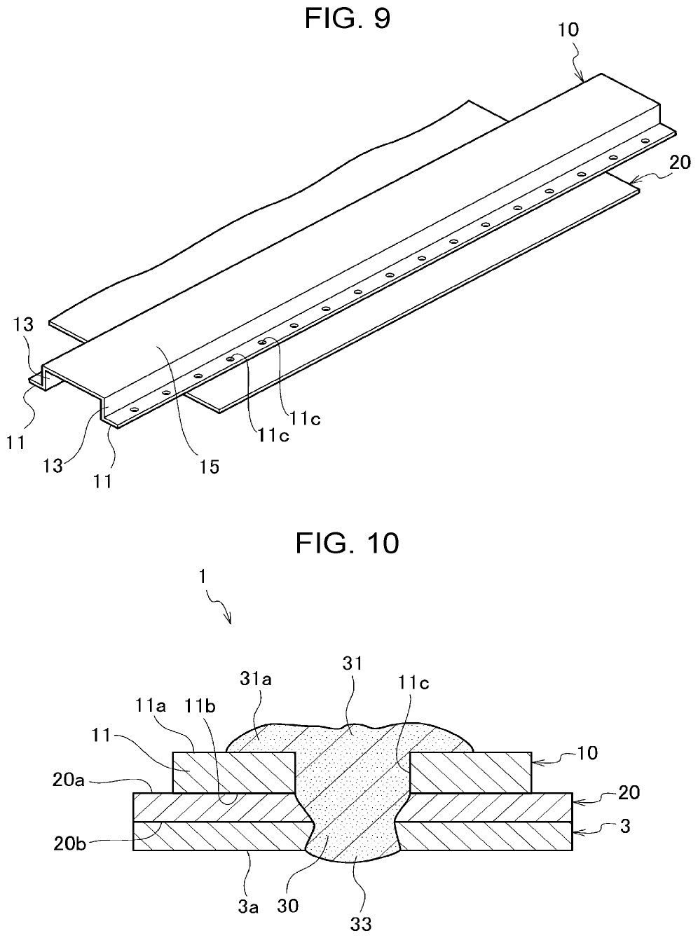

In the embodiments described above, the upper sheet 10 made of steel is a member with an approximately L-shaped cross section composed of the base portion 11 and the upright wall 13 and may have another shape, provided that the upper sheet 10 has the base portion 11 and the upright wall 13. FIG. 9 is a perspective view of the upper sheet 10 and the lower sheet 20 according to a first modified example.

The upper sheet 10 in FIG. 9 is a hat-shaped steel and has a pair of flat base portions 11 and 11, a pair of upright walls 13 and 13 standing on the inner end portions of the pair of base portions 11 and 11, and a flat connecting portion 15 connecting edges of the pair of upright walls 13 and 13. A plurality of through-holes 11c are formed in the base portion 11 at intervals in the longitudinal direction of the upper sheet 10.

Even when the upper sheet 10 has a different shape as in this example, the upper sheet 10 and the lower sheet 20 can be arc-welded by the arc spot welding method for joining dissimilar materials described in the above embodiments. More specifically, the pair of base portions 11 and 11 of the upper sheet 10 is superimposed on the lower sheet 20, and the plurality of through-holes 11c are filled with molten weld metal to join the pair of base portions 11 and 11 and the lower sheet 20.

### Second Modified Example

FIG. 10 is a cross-sectional view of the dissimilar material welded joint 1 around the through-hole 11c according to a second modified example. The dissimilar material welded joint 1 in FIG. 10 includes a bottom sheet 3 made of nonferrous metal (a third sheet) in addition to the upper sheet 10 made of steel (the first sheet) and the lower sheet 20 made of nonferrous metal (the second sheet). The lower sheet 20 and the bottom sheet 3 are made of the same material, for example, an aluminum alloy.

Even when the bottom sheet 3 is provided below the lower sheet 20 as in this example, the upper sheet 10, the lower sheet 20, and the bottom sheet 3 can be joined by the arc spot welding method for joining dissimilar materials described in the above embodiments. More specifically, the base portion 11 of the upper sheet 10, the lower sheet 20, and the bottom sheet 3 are superimposed, and the through-hole 11c is filled with molten weld metal. As a result, the excess weld 31 of the weld metal 30 is formed on the front surface 11a of the upper sheet 10, and the weld metal 30 is melted into a back surface 3a of the bottom sheet 3 such that the penetration bead 33 appears, thereby joining the base portion 11 of the upper sheet 10, the lower sheet 20, and the bottom sheet 3.

### Third Modified Example

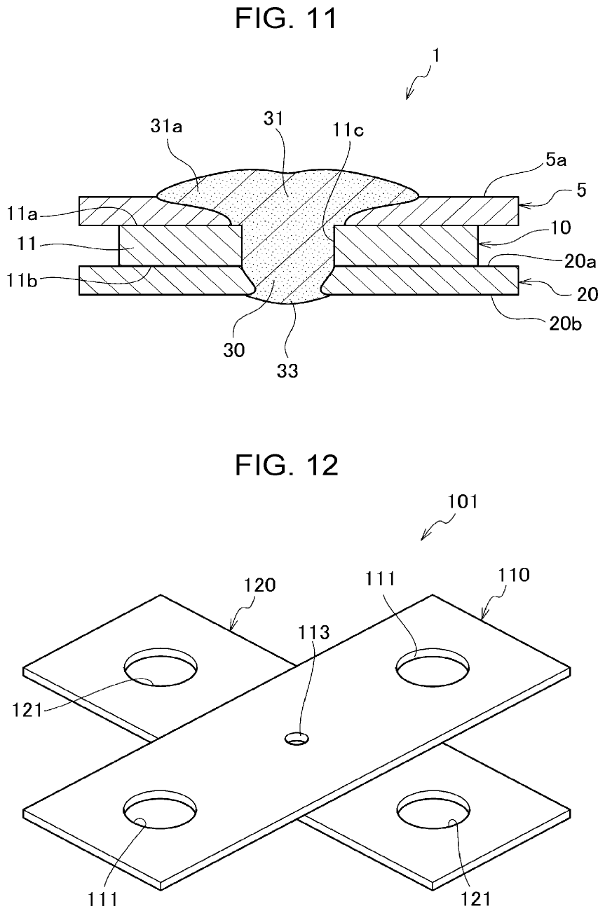

FIG. 11 is a cross-sectional view of the dissimilar material welded joint 1 around the through-hole 11c according to a third modified example. The dissimilar material welded joint 1 in FIG. 11 includes a top sheet 5 made of nonferrous metal (a third sheet) in addition to the upper sheet 10 made of steel (the first sheet) and the lower sheet 20 made of nonferrous metal (the second sheet). The lower sheet 20 and the top sheet 5 are made of the same material, for example, an aluminum alloy.

Even when the top sheet 5 is provided above the base portion 11 of the upper sheet 10 as in this example, the top sheet 5, the upper sheet 10, and the lower sheet 20 can be joined by the arc spot welding method for joining dissimilar materials described in the above embodiments. More specifically, the top sheet 5, the base portion 11 of the upper sheet 10, and the lower sheet 20 are superimposed, and the plurality of through-holes 11c are filled with weld metal while an upper portion of the through-holes 11c in the top sheet 5 is melted with molten weld metal. As a result, the excess weld 31 of the weld metal 30 is formed on the front surface 11a side of the upper sheet 10 (more specifically, on a front surface 5a of the top sheet 5), and the weld metal 30 is melted into the back surface 20b of the lower sheet 20 such that the penetration bead 33 appears, thereby joining the top sheet 5, the base portion 11 of the upper sheet 10, and the lower sheet 20.

### (Joint Strength Test)

To evaluate the relationship between the joint strength and the amounts of extension W1 and W2 of the flange portion 31a of the excess weld 31 of the weld metal 30 described above, a cross tensile strength (CTS) test was conducted in which a tensile load was applied in the separation direction to a welded joint produced by spot-welding crossed members to be welded. The cross tensile test is specified in JIS Z 3137.

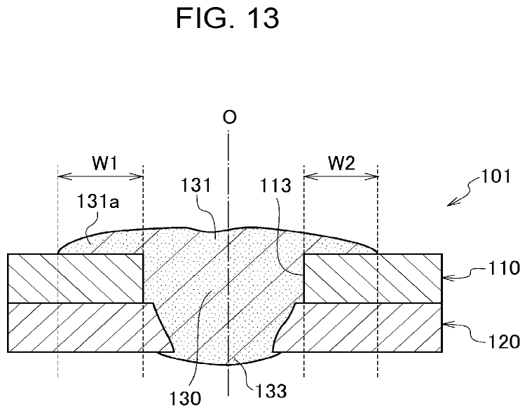

FIG. 12 is a perspective view of a test joint 101 for the cross tensile test. FIG. 13 is a cross-sectional view of the test joint 101 around a through-hole 113.

The test joint 101 is a welded cross joint produced by superimposing a rectangular upper sheet 110 made of steel and a rectangular lower sheet 120 made of an aluminum member in a cross shape and welding the central portion thereof by the arc spot welding method for joining dissimilar materials.

A pair of bolt holes 111 and a pair of bolt holes 121 for fixing the upper sheet 110 and the lower sheet 120 to a tensile test jig with bolts are provided at each end portion of the upper sheet 110 and the lower sheet 120. Furthermore, the through-hole 113 penetrating in the vertical direction is provided in the center of the upper sheet 110 and is filled with molten weld metal 130 to arc-weld the upper sheet 110 and the lower sheet 120.

In such arc welding, the through-hole 113 in the upper sheet 110 is filled with the weld metal 130 produced by melting of a filler material. Thus, an excess weld 131 was formed on the front surface of the upper sheet 10, and the weld metal 130 was melted such that a penetration bead 133 appeared on the back surface of the lower sheet 120, thereby joining the upper sheet 110 and the lower sheet 120. FIG. 13 illustrates the center O of the through-hole 113, the amount of extension W1 of a flange portion 131a of the excess weld 131 of the weld metal 130 from the peripheral surface of the through-hole 113 toward one side (the left side in the drawing), and the amount of extension W2 of the flange portion 131a from the peripheral surface of the through-hole 113 toward the other side (the right side in the drawing).

In the cross tensile test, the cross tensile strength (CTS) of the test joint 101 was measured while the amounts of extension W1 and W2 were changed. The measurement results showed that the CTS tended to increase as W1/W2 approached 1. In particular, the CTS was high for 0.4≤W1/W2≤2.5 and was higher for 0.7≤W1/W2≤1.4.

Under the same conditions, a tensile shear test was conducted in accordance with JIS Z 3136, and the tensile shear strength (TSS) was almost the same regardless of the value of W1/W2. It is thought that TSS is correlated with the nugget diameter or the weld metal hardness, whereas CTS is changed with toughness and stress concentration. In the test joint, it is thought that the influence of the decrease in toughness due to the inclusion of weld metal in the steel and stress concentration due to the formation of flat weld metal was strong, and the difference in W1/W2 appeared as the difference in CTS.

### EXAMPLES

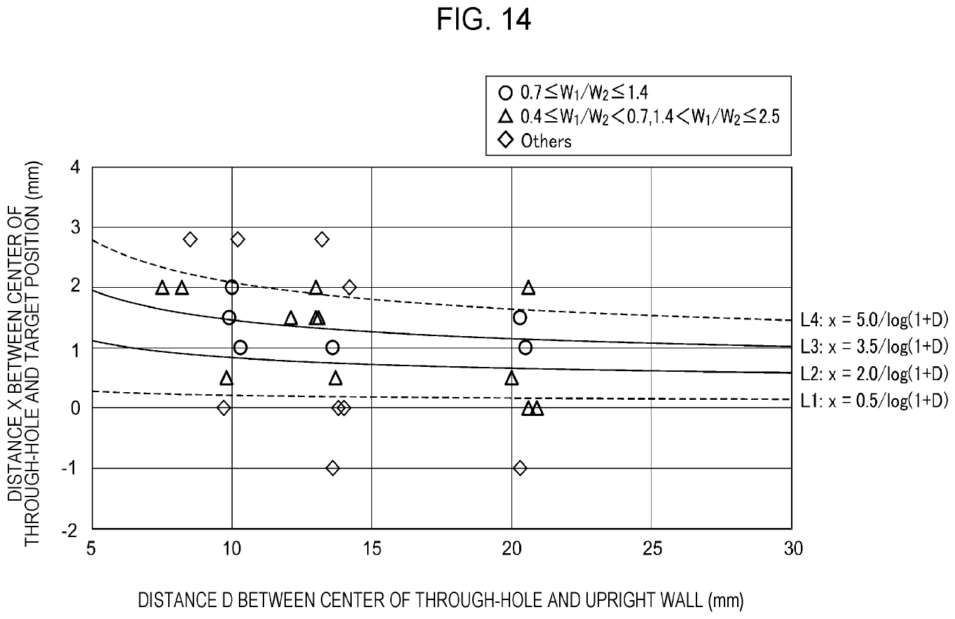

Under the conditions shown below in Table 1, the upper sheet 10 and the lower sheet 20 were joined by dissimilar material arc spot welding to form the dissimilar material welded joint 1 as illustrated in FIGS. 1 and 2. FIG. 14 summarized the relationship between the distance D between the center O of the through-hole 11c and the upright wall 13, the distance X between the center O of the through-hole 11c and the target position T, and W1/W2. As described above, for the distance X, the amount of deviation of the target position T from the center O of the through-hole 11c in the direction opposite to the upright wall 13 is a positive value, and the amount of deviation of the target position T from the center O of the through-hole 11c in the direction toward the upright wall 13 is a negative value.

TABLE 1

| | |
|---|---|
| Upper sheet 10 | Cold-rolled steel sheet SPCC |
| | Thickness: 1.4 mm |
| Lower sheet 20 | Aluminum alloy A6022 |
| | Thickness: 2.0 mm |
| Diameter of through-hole 11c | 7 mm |
| Welding mode | Pulse |
| Welding conditions | 135 A-23 V-1.5 s |
| Welding wire | JIS A5356-WY 1.2 mm |
| | (5000 series aluminum wire) |
| Shielding gas | 100% argon |
| | 25 L/min |

In FIG. 14, the relationship between the distance D and the distance X is plotted, and each plotted point is represented by a circle, a triangle, or a square depending on the value of W1/W2. A point represented by a circle is the data of the dissimilar material welded joint 1 that satisfies 0.7≤W1/W2≤1.4 and has higher joint strength. A point represented by a triangle is the data of the dissimilar material welded joint 1 that satisfies 0.4≤W1/W2<0.7 or 1.4<W1/W2≤2.5 and has high joint strength. A point represented by a square is the data of the dissimilar material welded joint 1 that does not satisfy 0.4≤W1/W2≤2.5 and has relatively low joint strength.

It can be seen that the joint strength decreases relatively as the distance D decreases. This is probably because the effects of the magnetic arc blow increase as the distance D decreases. In particular, the effects of the magnetic arc blow are large at a distance D of 15 mm or less and are larger at a distance D of 10 mm or less. At a distance D of 15 mm or less, the joint strength is relatively low when X=0 (when the target position T of the welding wire 51 is aligned with the center O of the through-hole 11c of the base portion 11).

As shown by logarithmic curves L1 and L4 in FIG. 14, it has become clear that when 0.5/log(1+D)≤X≤5.0/log(1+D) is satisfied in particular, the dissimilar material welded joint 1 satisfies 0.4≤W1/W2≤2.5 and has high joint strength. Furthermore, as shown by logarithmic curves L2 and L3, it has become clear that when 2.0/log(1+D)≤X3.5/log(1+D) is satisfied, the dissimilar material welded joint 1 satisfies 0.7≤W1/W2≤1.4 and has higher joint strength. In particular, even if the distance D is 15 mm or less and the magnetic arc blow has a large effect, the dissimilar material welded joint 1 has high joint strength when the distances D and X satisfy the above relationships.

Although the arc spot welding method for joining dissimilar materials and the dissimilar material welded joint according to each embodiment have been described above in detail, the present invention is not limited to these embodiments and modified examples, and appropriate modifications, improvements, and the like can be made. For example, the order of welding steps in each embodiment and each modified example is not limited to that described above and may be appropriately changed.

As described above, the present description discloses the following.

(1) An arc spot welding method for joining dissimilar materials for joining a first sheet made of steel and a second sheet made of nonferrous metal, wherein
the first sheet has a flat base portion and an upright wall standing on the base portion, and
the base portion has a through-hole, and the method includes: a superimposing step of superimposing the base portion on the second sheet such that the second sheet is exposed through the through-hole; and
a filling and welding step of filling the through-hole with a molten weld metal at a target position shifted from a center of the through-hole in the direction opposite to the upright wall and arc-welding the base portion and the second sheet.

This configuration can improve the circularity of the weld metal, improve the joint strength, and join the dissimilar materials of the first sheet made of steel and the second sheet made of nonferrous metal with high strength and high reliability.

(2) The arc spot welding method for joining dissimilar materials according to (1), wherein a distance D between the center of the through-hole and the upright wall and a distance X between the center of the through-hole and the target position satisfy 0.5/log(1+D) X.

According to this configuration, setting the distance in the above range can increase the distance (D+X) between the target position and the upright wall and reduce the effects of the magnetic arc blow. Furthermore, even when the weld metal is deflected toward the upright wall by the magnetic arc blow, the weld metal has high circularity with respect to the center of the through-hole as a reference because the target position is shifted by the distance X to the side opposite the upright wall.

(3) The arc spot welding method for joining dissimilar materials according to (1) or (2), wherein X≤5.0/log(1+D) is satisfied.

According to this configuration, the distance (D+X) between the target position and the upright wall does not become too large, and the weld metal has high circularity with respect to the center of the through-hole as a reference.

(4) The arc spot welding method for joining dissimilar materials according to any one of (1) to (3), wherein the distance D between the center of the through-hole and the upright wall is 15 mm or less.

This configuration can satisfactorily join the first sheet and the second sheet even when the magnetic arc blow has a relatively large effect.

(5) The arc spot welding method for joining dissimilar materials according to any one of (1) to (5), wherein
an excess weld of the weld metal is formed on a front side of the first sheet in the filling and welding step,
the excess weld has a flange portion extending to an outer peripheral side from a peripheral surface of the through-hole, and
an amount of extension W1 of the flange portion from the peripheral surface of the through-hole toward an upright wall side and an amount of extension W2 of the flange portion from the peripheral surface of the through-hole in the direction opposite to the upright wall satisfy 0.4≤W1/W2≤2.5.

According to this configuration, the weld metal has high circularity with respect to the center of the through-hole as a reference.

(6) The arc spot welding method for joining dissimilar materials according to (5), wherein 0.7≤W1/W2≤1.4 is satisfied.

According to this configuration, the weld metal has higher circularity with respect to the center of the through-hole as a reference.

(7) The arc spot welding method for joining dissimilar materials according to any one of (1) to (6), wherein the second sheet is made of aluminum or an aluminum alloy, and the weld metal is aluminum or an aluminum alloy.

This configuration can join the dissimilar materials of the first sheet made of steel and the second sheet made of an aluminum member with high strength and high reliability.

(8) A dissimilar material welded joint formed by the arc spot welding method for joining dissimilar materials according to any one of (1) to (7).

This configuration can improve the circularity of the weld metal, improve the joint strength, and join the dissimilar materials of the first sheet made of steel and the second sheet made of nonferrous metal with high strength and high reliability.

Although various embodiments have been described above with reference to the drawings, it goes without saying that the present invention is not limited to these examples. It will be apparent to those skilled in the art that various variations and modifications can be made within the scope of the appended claims, and it is understood that they also fall within the technical scope of the present invention. The constituents in the above embodiments may be arbitrarily combined without departing from the gist of the present invention.

The present application is based on Japanese Patent Application (Japanese Patent Application No. 2021-135926) filed on Aug. 23, 2021, the contents of which are incorporated herein by reference.

### REFERENCE SIGNS LIST

1 dissimilar material welded joint
3 bottom sheet
3a back surface
5 top sheet
5a front surface
10 upper sheet (first sheet)
11 base portion
11a front surface
11b back surface
11c through-hole
13 upright wall
15 connecting portion
20 lower sheet (second sheet)
20a front surface
20b back surface
30 weld metal
31 excess weld
31a flange portion
33 penetration bead
50 arc welder
51 welding wire
101 test joint
110 upper sheet
111 bolt hole
113 through-hole
120 lower sheet
121 bolt hole
A arc
G shielding gas
O center
W1, W2 amount of extension
θ angle

1. An arc spot welding method for joining dissimilar materials for joining a first sheet made of steel and a second sheet made of nonferrous metal, wherein
the first sheet has a flat base portion and an upright wall standing on the base portion, and
the base portion has a through-hole, and the method comprises: a superimposing step of superimposing the base portion on the second sheet such that the second sheet is exposed through the through-hole; and
a filling and welding step of filling the through-hole with a molten weld metal at a target position shifted from a center of the through-hole in a direction opposite to the upright wall and arc-welding the base portion and the second sheet.

2. The arc spot welding method for joining dissimilar materials according to claim 1, wherein a distance D between the center of the through-hole and the upright wall and a distance X between the center of the through-hole and the target position satisfy 0.5/log(1+D)≤X.

3. The arc spot welding method for joining dissimilar materials according to claim 1, wherein a distance D between the center of the through-hole and the upright wall and a distance X between the center of the through-hole and the target position satisfy X≤5.0/log(1+D).

4. The arc spot welding method for joining dissimilar materials according to claim 1, wherein the distance D between the center of the through-hole and the upright wall is 15 mm or less.

5. The arc spot welding method for joining dissimilar materials according to claim 1, wherein
an excess weld of the weld metal is formed on a front side of the first sheet in the filling and welding step,
the excess weld has a flange portion extending to an outer peripheral side from a peripheral surface of the through-hole, and
an amount of extension W1 of the flange portion from the peripheral surface of the through-hole toward an upright wall side and an amount of extension W2 of the flange portion from the peripheral surface of the through-hole in a direction opposite to the upright wall satisfy 0.4≤W1/W2≤2.5.

6. The arc spot welding method for joining dissimilar materials according to claim 5, wherein 0.7≤W1/W2≤1.4 is satisfied.

7. The arc spot welding method for joining dissimilar materials according to claim 1, wherein the second sheet is made of aluminum or an aluminum alloy, and the weld metal is aluminum or an aluminum alloy.

8. A dissimilar material welded joint formed by the arc spot welding method for joining dissimilar materials according to claim 1.
